(19) United States
(12) Patent Application Publication
(10) Pub. No.: US 2005/0138307 A1
(43) Pub. Date: Jun. 23, 2005

(54) Storage performance improvement using data replication on a disk

(76) Inventors: Knut S. Grimsrud, Forest Grove, OR (US); Amber D. Huffman, Banks, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/742,479

(22) Filed: Dec. 18, 2003

(51) Int. Cl. G06F 12/00

(52) U.S. Cl. 711/162; 711/112

(57) ABSTRACT

In some embodiments, disk accesses made during normal operation of a disk drive are monitored. One or more data blocks on the disk drive are identified as candidates for replication on the disk drive in response to the monitoring. Each of the identified data blocks are replicated in at least one other place on the disk drive. Other embodiments are described and claimed.

### TECHNICAL FIELD

The inventions generally relate to storage performance improvement using data replication on a disk.

### BACKGROUND

Computer systems used today typically include at least one disk drive, and disk drives are now being included within additional consumer products as well (for example, digital video recorders). Capacity of these disk drives has been steadily increasing at a fast pace. Historically, disk drive capacity doubles approximately every 18 months. The largest drives are now over 300 GB, and available capacities appear to be exceeding user demand. Disk drives contain one or more platters, and the size of newer disk drive platters is 80 GB.

While disk drive capacity has been steadily increasing, disk drive performance has remained stagnant. This is due to inherent limitations of the mechanical platform on which disk drives are based. It is only possible to accelerate a moving mass to a certain speed while staying within cost and power constraints of mainstream platforms. As a result, disk drive performance has not kept pace with computer platform performance trends, resulting in the disk drive becoming a larger negative contributor to overall platform performance. It would be advantageous to have a disk drive system in which disk performance is accelerated so that the overall platform performance is not hindered.

Previously, data was duplicated across multiple disk drives using Redundant Arrays of Independent Disk (RAID) technology. However, the requirement of RAID implementations of multiple drives and associated control hardware and/or software adds a significant cost to the system. Additionally, some disk drive vendors have experimented with creating a copy of each data block written on a disk drive at a place on the block that is rotationally 180 degrees from the original. This approach is a brute force approach and results in the disadvantage that half of the storage capacity of the disk is lost. Additionally, this approach also results in write performance penalties. Since every block of data on the drive is blindly replicated using this approach all write operations to a data block must update both copies of that block.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a disk drive platter according to some embodiments of the inventions.

FIG. 2 is a system according to some embodiments of the inventions.

FIG. 3 illustrates a flow chart diagram according to some embodiments of the inventions.

FIG. 4 illustrates a flow chart diagram according to some embodiments of the inventions.

### DETAILED DESCRIPTION

Some embodiments of the inventions relate to storage performance improvement using data replication on a disk.

In some embodiments, disk accesses made during normal operation of a disk drive are monitored. One or more data blocks on the disk drive are identified as candidates for replication on the disk drive in response to the monitoring. Each of the identified data blocks are replicated in at least one other place on the disk drive.

In some embodiments, a system includes a disk drive and a controller (or agent). The controller (agent) is used to monitor disk accesses made during normal operation of the disk drive, to identify one or more data blocks on the disk drive as candidates for replication on the disk drive in response to the monitoring, and to replicate each of the identified data blocks in at least one other place on the disk drive.

In some embodiments an apparatus includes a monitor that can monitor disk accesses made during normal operation of a disk drive. The apparatus also includes a controller (or agent) to identify one or more data blocks on the disk drive as candidates for replication on the disk drive in response to the monitoring and to replicate each of the identified data blocks in at least one other place on the disk drive.

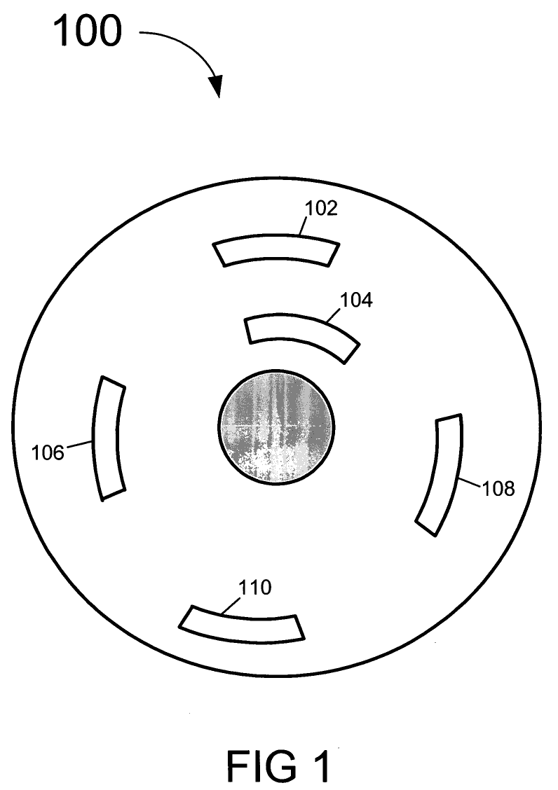

FIG. 1 illustrates a disk platter 100 of a disk drive according to some embodiments. Disk platter 100 includes an original data block 102, an alias data block 104, an alias data block 106, an alias data block 108 and an alias data block 110. Although the alias data blocks 104, 106, 108 and 110 are referred to as alias data blocks in reference to FIG. 1, they may be called other similar names such as copy data blocks, replicated data blocks, etc. Alias data blocks 104, 106, 108 and 110 contain the same data as the original data block 102, but are replicated and strategically provided in other portions of the drive platter in order to allow for quicker access times when the data is needed. When access to the data contained within original data block 102 is needed a determination is made as to which of the data blocks 102, 104, 106, 108 and 110 can be accessed the quickest and that data block is accessed to obtain the data. According to some embodiments, every original block of data on the disk platter 100 is not copied, but the data that is most likely to be needed is replicated and associated alias data blocks are provided (for example, the most frequently accessed data on the disk platter 100 is replicated using alias blocks in a manner similar to that illustrated in FIG. 1). In some embodiments one criteria that is used in selecting which original blocks of data to select for replication and provision of alias blocks is to select blocks that are read-only blocks (or are primarily read-only blocks). Such a selection criteria helps to reduce any performance penalties due to a very low write rate to the aliased (replicated) blocks.

According to some embodiments, disk performance may be accelerated by converting excess capacity into improved access speed. This may be accomplished by identifying portions of the disk that are the most heavily utilized, and replicating those portions to other regions of the disk that are unused. The resulting copied “aliases” can be distributed across the surface of the disk in a way that minimizes disk access times for those blocks by providing several different alternative locations from which the data can be retrieved. For example, in some embodiments the most heavily used 3% of the disk drive could be replicated ten times across the surface of the disk in order to reduce the effective seek distances to that data (in some cases, possibly by a factor of ten).

In some embodiments alias (replicated) block placement is performed in an attempt to make a best use of both seek distance and rotational delay minimizations. For example, in some embodiments alias blocks are placed on the disk in pairs (or in other multiples). A pair is two aliases on the same track of the disk, 180 degrees out of phase with each other. By placing data in pairs on the same track, the average rotational latency is cut in half. Multiple sets of pairs can then be placed on different tracks. By placing pairs on different tracks throughout the drive surface, seek distances can be minimized. Thus, both seek distance and rotational delay can be minimized.

In some embodiments the proper data to replicate is identified, the disk block aliases are created and managed on the disk drive (in some embodiments in an operating system independent manner, in other embodiments in an operating system dependent manner), and the one optimal block to access is selected for subsequent operations from the original data block and each of the disk block alias in order to maximize performance.

In some embodiments some of the original blocks on a disk are identified as blocks for which to create alias blocks, the number of alias blocks to create is determined, and the location to place the alias blocks on the disk is determined. In some embodiments the number of aliases to create may be dynamic based on how frequently the block is accessed, for example. One block may have ten aliases, for example, while a less important block may only have four aliases created for it.

In some embodiments the performance of a single-drive system can be increased. In some embodiments the most critical data may be intelligently selected for replication. In some embodiments multiple aliases of the original data are created and placed in strategic places on the disk. In some embodiments the performance may be improved in an operating system independent manner. In some embodiments the performance may be improved in an operating system dependent manner. In some embodiments many of the implemented functions may be performed in a device driver, which results in an improvement in performance in an operating system dependent manner. In some embodiments block replication is implemented in a file system unaware manner (or file system transparent manner). One way to do block replication or aliasing according to some embodiments is for the file system to create multiple copies of a file and request that the storage driver read the correct file. The methodology outlined herein does not require any file system modification and is transparent to the file system. The file system only creates and manages one file. In some embodiments the alias blocks are created by the storage driver without the knowledge of the file system. This allows any standard file system to be used.

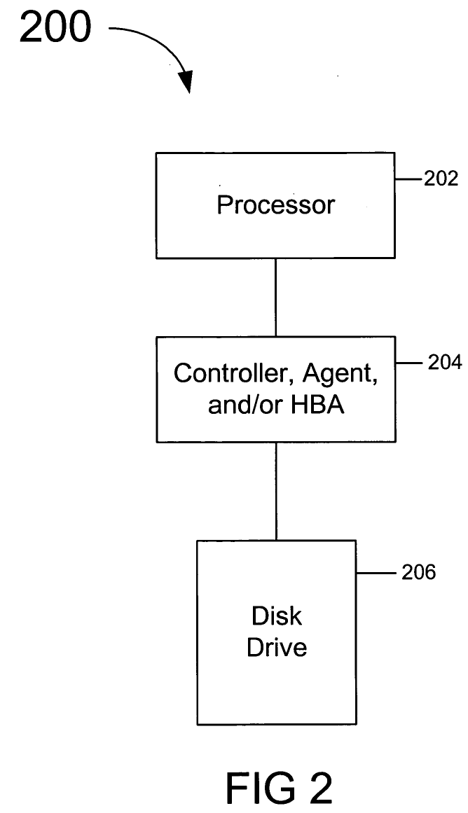

FIG. 2 illustrates a block diagram of a system 200 according to some embodiments. System 200 may be a computer system, and includes a processor 202, a controller 204 (or agent) and a disk drive 206. Processor 202 may be any processor, including a CPU (central processing unit). Controller 204 may be an agent, a host bus adapter, a disk controller and/or any other type of controller. In some embodiments controller or agent 204 may be contained within one component (for example, all in software running on processor 202 or all within a host bus adapter). In some embodiments controller or agent 204 may be distributed across software running on a processor 202, a host bus adapter, and the disk drive (in such embodiments the controller 204 in FIG. 2 would actually be a host bus adapter with the distributed software providing the functions described herein as running on the controller or agent). Although it is shown as a separate device from processor 202 and disk drive 206, controller 204 may be included within a disk drive such as disk drive 206, within a processor such as processor 202, or in some other part of the system. Controller 204 may also be distributed over different elements of the system (for example, some of controller 204 within processor 202 and some within disk drive 206), and may be implemented in hardware, firmware and/or software. In some embodiments the disk drive is connected using Serial ATA.

In some embodiments a controller such as controller 204 is used to implement accelerated disk drive performance. The controller can include a monitor that monitors disk accesses that are made during normal operation of the system. The monitor may be implemented, for example, as a background task running in software. The controller can also include an analyzer that analyzes the monitored disk accesses and identifies blocks of data on the disk drive that are the most frequently accessed, and targets those blocks as candidates for replication. Further selection criteria may also be applied to the analysis (for example, whether the blocks are primarily read-only blocks, which would make them good candidates for replication and/or other selection criteria). The controller may also include a copier (or replicator) for replicating selected disk block replication candidates on the disk several different times in different places (for example, as alias data blocks 104, 106, 108 and/or 110 as illustrated in FIG. 1). The number of replicated aliases may be based on additional criteria such as frequency of access, available remaining disk space, and/or other criteria. Aliases of the selected block may be created in selected regions of the disk, largely based on available disk regions and/or what other blocks are typically accessed in close temporal proximity with the target data. The controller can place the alias near portions of the disk that are used in conjunction with the selected block. In some embodiments one surface of one disk platter may be reserved for aliased blocks. This can allow that reserved surface to place blocks at any lateral position on the disk drive, thus affording good placement flexibility.

In some embodiments creation of the alias is coordinated with a device driver that is aware of the aliased disk blocks. The device driver can include knowledge of placement of all disk block aliases on the disk. When a subsequent disk access is made, the device driver can determine whether aliased versions of the requested data exist. If aliases exist, then the selection of the optimal one block of the original block and the aliases of that original block is made.

In some embodiments only the disk drive can optimally select the best block to access of the original and the aliases based on the current angular position of the platter and the organization of the blocks on the disk media. The aliases that the drive can select from can be communicated to the drive for the selection of the optimal one of the original block and the aliases. Once the disk drive receives the possible aliases from which to choose the optimal block, it can select from the possible original and alias choices by using internal disk drive algorithms that are the same as or very similar to optimizations that disk drives perform for queued command execution, for example. The disk drive is thus able to select the one block of the original and the aliases that it can access the fastest and disregards the other possible aliases.

In some embodiments, as capacity is required as a result of the disk drive filling up with data, performance can be converted back to capacity by reducing the number of disk aliases on the disk (for example, by reducing the number of aliases associated with each original data block, by reducing all aliases for certain original data blocks, or some other way of reducing the number of aliases on the disk). In some embodiments, as capacity is required as a result of the disk drive filling up with data, all aliases on the disk may be eliminated. Therefore, the drive can be considered both large and high performance (although the performance may gracefully degrade as the disk is filled). This allows excess capacity on a disk to be converted to performance without necessary limiting a user's ability to use the entire capacity of the disk when it is needed.

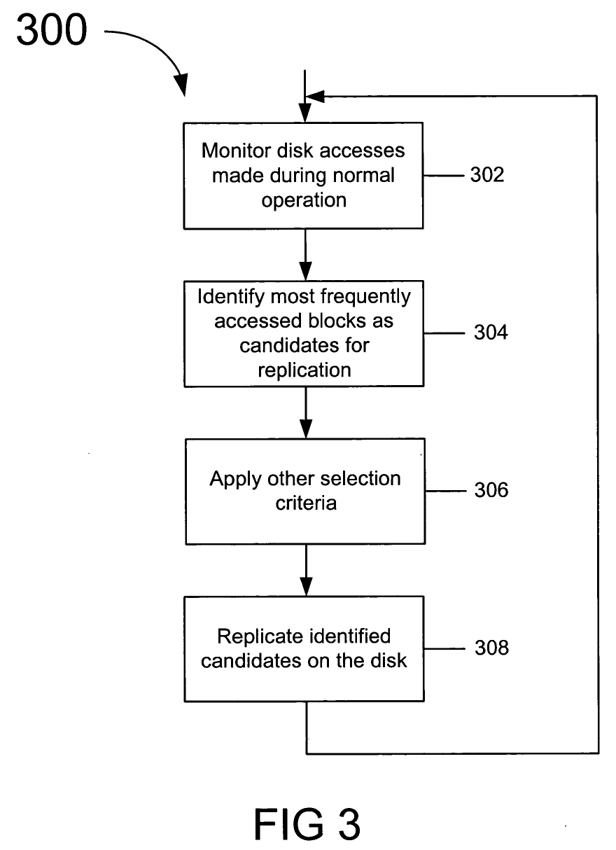

FIG. 3 illustrates a flow chart 300 according to some embodiments. In some embodiments, flow 300 may be implemented in software, but may be implemented in other ways such as hardware and/or firmware in other embodiments. Flow 300 may be implemented in software run on a central processing unit of a system or some other processor in a system, on a controller used to control the disk that is internal to or external to the disk unit, or in some other manner. Flow 300 of FIG. 3 illustrates how alias disk blocks can be added to a disk drive according to some embodiments. In some embodiments flow 300 is operating system independent. In some embodiments flow 300 may be implemented using controller or agent 204 of FIG. 2, processor 202 of FIG. 2, disk unit 206 of FIG. 2, a controller within disk unit 206 and/or in some combination of those elements.

At 302 disk accesses made during normal operation are monitored. This may be implemented, for example, using some type of background task. At 304 the most frequently accessed blocks are identified as candidates for replication. The identification may be performed, for example, by analyzing blocks that are most frequently accessed and targeting those blocks for replication. According to some embodiments, other selection criteria may be used at 304 in addition to or instead of analyzing the most frequently accessed blocks. For example, blocks having the longest access time may be analyzed and/or other selection criteria may be applied at 304 in addition to or instead of analyzing the most frequently accessed blocks. At 306 other selection criteria are applied (for example, whether the blocks are read-only, some other selection criteria, or no other selection criteria at all by skipping 306). At 308 the identified candidates are replicated on the disk. The original data block may be replicated on the disk several times in strategic places. The number and place of the replicated aliases may be based on additional criteria such as frequency of access, available remaining disk space, etc. In some embodiments some of the elements of FIG. 3 may be eliminated, others may be added and/or ordering may be changed. In some embodiments the process for creating alias blocks as illustrated in FIG. 3 is a continual and incremental process. In order to reflect such embodiments flow in FIG. 3 is illustrated as flowing from 308 back up to the top of 302 so that the process is continual.

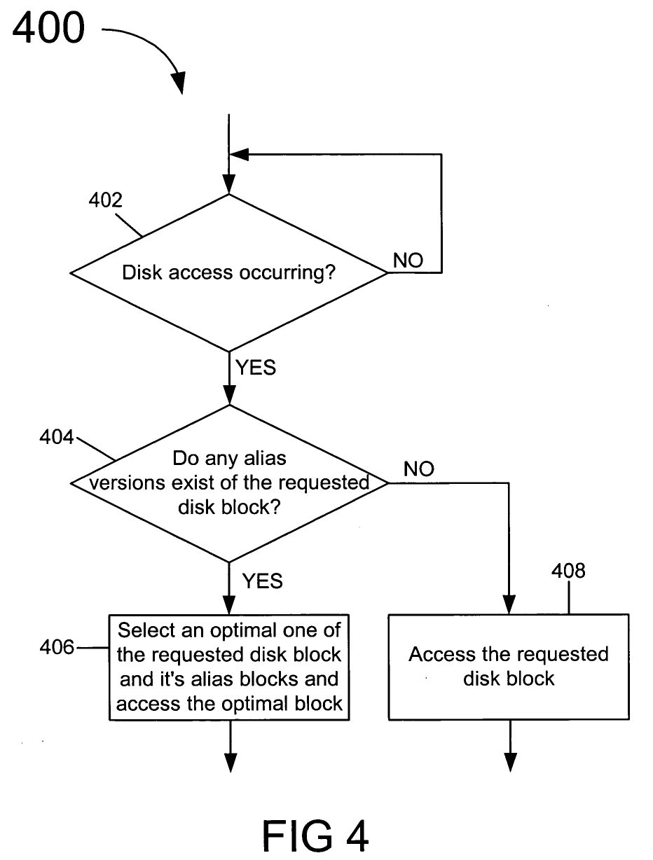

FIG. 4 illustrates a flow chart 400 according to some embodiments. In some embodiments, flow 400 may be implemented in software, but may be implemented in other ways such as hardware and/or firmware in other embodiments. Flow 400 may be implemented in software run on a central processing unit of a system or some other processor in a system, on a controller used to control the disk that is internal to or external to the disk unit, or in some other manner. In some embodiments flow 400 shows how flow is implemented to identify which disk to access after aliases have already been added to a disk drive. In some embodiments flow 400 is operating system independent. In some embodiments flow 400 may be implemented using controller 204 of FIG. 2, processor 202 of FIG. 2, disk unit 206 of FIG. 2, a controller within disk unit 206, and/or in some combination of those elements.

At 402 a determination is made as to whether or not a disk access is occurring. If a disk access is not occurring at 402 flow stays at that point until a disk access occurs. Once a determination is made at 402 that a disk access is occurring then flow goes to 404. At 404 a determination is made as to whether any alias disk blocks exist that correspond to the original requested disk block. If so, a selection is made of the optimal one of the requested original disk block and each of the aliases associated with that requested original disk block, and the selected optimal one of the original block and the replicated alias blocks is accessed at 406. If no alias disk blocks are identified at 404, then the requested disk block is accessed in a normal fashion at 408. In some embodiments some of the elements of FIG. 4 may be eliminated, others may be added and/or ordering may be changed.

Flow 400 illustrated in FIG. 4 is generally read-specific. That is, it applies only to disk reads and does not apply to disk writes. In some embodiments, for disk writes for data having a corresponding original block and one or more replicated alias blocks only the original block is updated and all of the replicated alias blocks are invalidated. In some embodiments, for disk writes for data having a corresponding original block and one or more replicated alias blocks both the original block and all of the replicated alias blocks are updated. In some embodiments for disk writes for data having a corresponding original block and one or more replicated alias blocks the original block is updated, and some of the replicated alias blocks are updated and some of the replicated alias blocks are invalidated.

In some embodiments if a write occurs to a data block having one or more replicated alias blocks the original block is written but the alias blocks are not updated. The alias blocks are invalidated so the written original block is no longer considered to have any aliases. At a later time, if the newly written block is again analyzed, selected and/or determined to have new alias blocks (for example, because a lot of read accesses to the original block are occurring), then the original block may get one or more new replicated alias blocks (that is, a new alias set) created for it.

Although most of the embodiments described above have been described in reference to particular implementations such as implementations including a controller implemented in software, other implementations are possible according to some embodiments. For example, the implementations described herein may be used to implement improved disk access in hardware and/or firmware according to some embodiments. Additionally, one criteria for analyzing and/or selecting blocks as candidates for replication has been described herein as analyzing and/or selecting the most frequently accessed blocks. However, other selection criteria are possible according to some embodiments. For example, the most frequently accessed blocks, the blocks that have the longest access times, and/or other selection criteria may be analyzed and/or selected for replication according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. A method comprising:
monitoring disk accesses made during normal operation of a disk drive;
identifying one or more data blocks on the disk drive as candidates for replication on the disk drive in response to the monitoring; and
replicating each of the identified data blocks in at least one other place on the disk drive.

2. The method according to claim 1, wherein the identified data blocks are at least one of data blocks on the disk drive that are most frequently accessed and data blocks on the drive that have longest access times.

3. The method according to claim 1, wherein the monitoring, identifying and the replicating are done in an operating system independent manner.

4. The method according to claim 1, wherein the monitoring, identifying and the replicating are done in an operating system dependent manner.

5. The method according to claim 1, further comprising:
when a disk access occurs, determining whether any replicated versions exist of a data block corresponding to the disk access.

6. The method according to claim 5, further comprising:
if any replicated versions exist, accessing a replicated version of the disk block.

7. The method according to claim 5, further comprising:
if any replicated versions exist, selecting an optimal block of the data block and the replicated versions and accessing the optimal block.

8. The method according to claim 7, wherein the optimal block is selected in response to at least one of a current angular position of a disk platter of the disk drive, a current lateral position of a disk head, and an organization of data blocks on the disk drive.

9. The method according to claim 7, wherein the optimal block is selected in response to a current angular position of a disk platter of the disk drive and a current lateral position of a disk head.

10. The method according to claim 7, wherein the optimal block is one of the original block and the replicated versions that can currently be accessed the fastest.

11. The method according to claim 5, further comprising:
if any replicated versions do not exist, accessing the data block corresponding to the disk access.

12. An article comprising:
A computer readable medium having instructions thereon which when executed cause a computer to:
monitor disk accesses made during normal operation of a disk drive;
identify one or more data blocks on the disk drive as candidates for replication on the disk drive in response to the monitoring; and
replicate each of the identified data blocks in at least one other place on the disk drive.

13. The article according to claim 12, wherein the identified data blocks are at least one of data blocks on the disk drive that are most frequently accessed and data blocks on the drive that have longest access times.

14. The article according to claim 12, wherein the monitoring, identifying and the replicating are done in an operating system independent manner.

15. The article according to claim 12, wherein the monitoring, identifying and the replicating are done in an operating system dependent manner.

16. A system comprising:
a disk drive; and
a controller to monitor disk accesses made during normal operation of the disk drive, to identify one or more data blocks on the disk drive as candidates for replication on the disk drive in response to the monitoring, and to replicate each of the identified data blocks in at least one other place on the disk drive.

17. The system according to claim 16, wherein the disk drive and the controller are included in a disk drive unit.

18. The system according to claim 16, wherein the controller is coupled to the disk drive.

19. The system according to claim 16, wherein a portion of the controller is included in a disk drive unit including the disk drive, and a portion of the controller is not included in the disk drive unit.

20. The system according to claim 16, further comprising a processor that includes the controller.

21. The system according to claim 16, further comprising a processor, wherein the controller is a software controller running on the processor.

22. The system according to claim 16, wherein the disk drive is coupled to the controller using Serial ATA.

23. An apparatus comprising:
a monitor to monitor disk accesses made during normal operation of a disk drive; and
a controller to identify one or more data blocks on the disk drive as candidates for replication on the disk drive in response to the monitoring and to replicate each of the identified data blocks in at least one other place on the disk drive.

24. The apparatus according to claim 23, wherein the apparatus is a disk controller.

25. The apparatus according to claim 24, wherein the disk controller is included in a disk drive unit housing the disk drive.

26. The apparatus according to claim 23, wherein the apparatus is a standalone intelligent controller.
